(19) United States
(12) Patent Application Publication
(10) Pub. No.: US 2015/0324721 A1
(43) Pub. Date: Nov. 12, 2015

(54) CLOUD BASED SELECTIVELY SCALABLE BUSINESS PROCESS MANAGEMENT ARCHITECTURE (CBSSA)

(71) Applicant: WIPRO LIMITED, BANGALORE (IN)

(72) Inventors: Soham Bhaumik, Bangalore (IN); Hemant Kumar, Mayur Vihar Phase - 1 (IN); Amit Krishna, Bangalore (IN); Nithya Ramkumar, Bangalore (IN); Sridhar Krishnaswamy, Bangalore (IN)

(21) Appl. No.: 14/313,250

(22) Filed: Jun. 24, 2014

(30) Foreign Application Priority Data
May 9, 2014 (IN) 2306/CHE/2014

(51) Int. Cl. G06Q 10/06

(52) U.S. Cl. CPC G06Q 10/06313

(57) ABSTRACT

Systems, methods, and non-transitory computer-readable media for a cloud based selectively scalable architecture (CBSSA) that may be used for selective and automatic up-scaling and downscaling of individual sub systems are disclosed. In this architecture sub systems may also be extended and added onto the system architecture independently without impacting the other sub systems. Hardware and Software provisioning techniques may be achieved at runtime using the APIs of the cloud infrastructure.

This application claims the benefit of Indian Patent Application No. 98/CHE/2014 filed Jan. 9, 2014, which is hereby incorporated by reference in its entirety.

### FIELD

The present disclosure relates generally to business process management systems, and more particularly to cloud based selectively scalable process management architecture.

### BACKGROUND

Business process management systems are typically built on monolithic architecture that has constraints at both hardware level and application level. Hence provision for automatic scalability and extensibility is very limited or does not exist. At the hardware level, it will not be able to achieve automatic scaling of resources to be made available for functional components to work on high loads. At the application level, it will not be able to make changes or extend the functionalities of the functional components with ease. In a scenario, where both at the hardware level and the application level, scalability is required, for example, if the system load increases on any of the functional component, then to scale this particular functional component separately is not possible as this component will be coupled with other functional aspects of the system. Therefore, presently to achieve the scalability of the resources, replica of the entire application need to be installed as another instance with use of the additional hardware resources and this will lead to manual work and will be a very expensive operation with respect to time and cost.

Referring to FIG. 1, a monolithic business process management architecture according to a prior art system is illustrated. As described above, the monolithic BPM architecture has several limitations. The BPM architecture comprises of one or more functional components that are coupled onto a platform.

Therefore, in view of the above drawbacks, it would be desirable to have systems, method, and non-transitory computer readable media for a cloud based selectively scalable architecture that allows scalability of a functional component independent of other functional components.

### SUMMARY

Disclosed herein is a method for selective scaling of one or more sub systems disposed in a cloud based business process management architecture. The method includes monitoring performance of each of the one or more sub systems to determine load existing on each of the one or more sub systems; selecting at least one sub system of the one or more sub systems based on the sub system load and performance Automatically at least one of scaling up or down the at least one sub system by at least one of allocating or collecting back hardware and software resources to the at least one sub system based on the sub system load and performance

In an aspect of the present disclosure, a device that selectively scales one or more sub systems disposed in a cloud based business process management architecture includes one or more hardware processors; a computer readable medium storing instructions that, when executed by the one or more hardware processors cause the one or more hardware processors to perform operations comprising: monitoring performance of each of the one or more sub systems to determine load existing on each of the one or more sub systems; selecting at least one sub system of the one or sub systems based on the sub system load and performance; and at least one of automatically scaling up or down, automatically, the at least one sub systems by at least one of allocating or collecting back hardware and software resources to the at least one sub system.

In another aspect of the present disclosure, a non-transitory computer-readable medium storing instructions for selective scaling of one or more sub systems disposed in a cloud based business process management architecture that, when executed by one or more hardware processors, cause the one or more hardware processors to perform operations comprising: monitoring performance of each of the one or more sub systems to determine load existing on each of the one or more sub systems; selecting at least one sub system of the one or sub systems based on the sub system load and performance; and at least one of automatically scaling up or down, automatically, the at least one sub system by at least one of allocating or collecting back hardware and software resources to the at least one sub system.

Additional objects and advantages of the present disclosure will be set forth in part in the following detailed description, and in part will be obvious from the description, or may be learned by practice of the present disclosure. The objects and advantages of the present disclosure will be realized and attained by means of the elements and combinations particularly pointed out in the appended claims.

### BRIEF DESCRIPTION OF THE DRAWINGS

The accompanying drawings, which constitute a part of this specification, illustrate several examples and, together with the description, serve to explain the disclosed principles. In the drawings:

FIG. 1 illustrates a business process management architecture according to a prior art system;

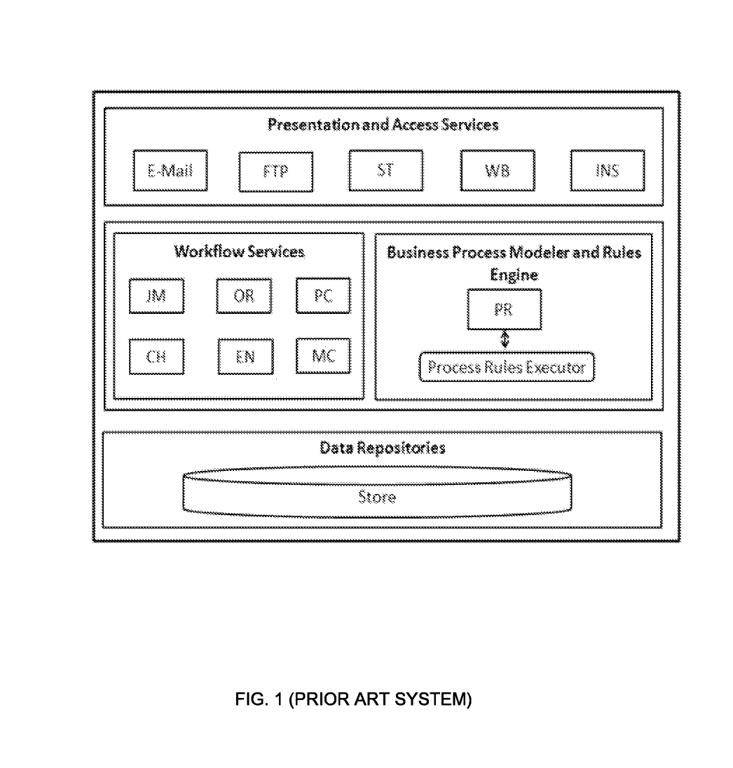

FIG. 2 is a block diagram of a high-level architecture of an exemplary system for selective scaling of one or more sub systems disposed in a cloud based business process management architecture;

FIG. 3 is a flowchart of an exemplary method for selective scaling of the one or more sub systems disposed in cloud based business process management architecture;

FIG. 4 illustrates working of an exemplary automatic application manager disposed in the system;

FIG. 5 illustrates working of an exemplary resource monitoring application (monitor) communicatively coupled to the automatic application manager; and

FIG. 6 is a block diagram of an example of a process management computing device.

### DETAILED DESCRIPTION

As used herein, reference to an element by the indefinite article “a” or “an” does not exclude the possibility that more than one of the element is present, unless the contextually requires that there is one and only one of the elements. The indefinite article “a” or “an” thus usually means “at least one.” The disclosure of numerical ranges should be understood as referring to each discrete point within the range, inclusive of endpoints, unless otherwise noted.

As used herein, the terms “comprise,” “comprises,” “comprising,” “includes,” “including,” “has,” “having,” “contains,” or “containing,” or any other variation thereof, are intended to cover a non-exclusive inclusion. For example, a composition, process, method, article, system, apparatus, etc. that comprises a list of elements is not necessarily limited to only those elements but may include other elements not expressly listed. The terms “consist of,” “consists of,” “consisting of,” or any other variation thereof, excludes any element, step, or ingredient, etc., not specified. The term “consist essentially of,” “consists essentially of,” “consisting essentially of,” or any other variation thereof, permits the inclusion of elements, steps, or ingredients, etc., not listed to the extent they do not materially affect the basic and novel characteristic(s) of the claimed subject matter.

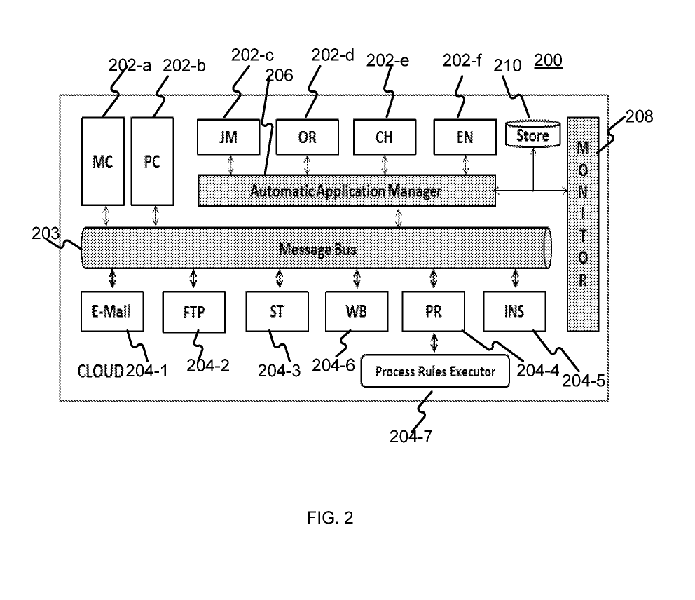

FIG. 2 is a block diagram of a high-level architecture of an exemplary system 200 for selective scaling of one or more sub systems (202-a, 202-b, 202-c etc) disposed in cloud based business process management architecture in accordance with an example of this technology. Each of the sub systems (202-a, 202-b, 202-c etc) may be independently integrated onto a platform. Since these sub systems (202-a, 202-b, 202-c etc) are independent, each of them may be monitored for performance and auto scalability and extensibility may be achieved with ease. Each of the sub systems (202-a, 202-b, 202-c etc) may be automatically scaled up or down based on load available currently at its disposal.

These sub system components may be integrated onto the platform using a message bus 203, using which communication happens between different sub systems (202-a, 202-b, 202-c etc). Each of these sub system (202-a, 202-b, 202-c etc) can have their own local databases/store as per functional or system requirement. This architecture may also help us in plugging in new sub systems on to the platform with minimum or no impact on the existing sub systems. Hence this feature may provide us the flexibility to be open for dynamicity of the changes going through the space of business process management.

Functionalities of the sub systems is described as follows:

Machine Configuration (MC): This sub system 202-a may be responsible for setting up required infrastructure or environment for the sub systems to be hosted and executed.

Process Configuration (PC): Process Configuration sub system 202-b may be responsible for defining or modeling a business process into a sub system executable component.

Job Management (JM): Job Management sub system 202-c may provide life cycle management of work items that are to be executed by human participants. Work items may be created as a result of events generated by other process sub systems.

Orchestration (OR): Orchestration sub system 202-d may provide enterprise integration facilities with external systems like SAP, BAAN, Oracle, Siebel etc. The required integration may be bi-directional request-response communication.

Choreography (CH): Choreography sub system 202-e may offer first level of interactions after receiving inputs from the gateways such as File Gateway, E-Mail Gateway, and FTP Gateway. Also may take care of life cycle of a business process with respect to instantiation, creation, deletion, and/or updating of a business process. Inter business process communication between each sub system may also be handled by this sub system.

Enactment (EN): Enactment sub system 202-f is the core sub system and back bone of all other sub systems, may help in communicating with the sub systems such as Choreography, Orchestration and Job Management.

It is to be noted that the MC 202-a and PC 202-b are directly connected to the message bus 203 whereas rest of the sub systems like JM, CH, OR etc are connected to the automatic application manager 206. The reason for this is that the MC and PC need not require their instances as these are one time activity and there would not be any load during the business process. Therefore there would not be up scaling/downscaling of load on the MC 202-a and PC 202-b

E-Mail Gateway: E-Mail gateway 204-1 may help in getting the messages in the form of mails.

File Transfer Protocol Gateway (FTP): FTP Gateway 204-2 may help in getting the messages from different server locations.

Scheduler Gateway (ST): Scheduler Gateway 204-3 may be used to trigger business process for the agents to work on based on pre-configured timer.

Process Rules Gateway (PR): Process Rules Gateway 204-4 may be used to connect to the desired process rules executor.

Insight Gateway Server (INS): Insight gateway server 204-5 may help in managing the historical profile of executed processes by enabling transaction query, SLA

Management, Process and business analytics.

Work Bench Gateway (WB): Work Bench Gateway 204-6 may provide the needed interface mechanism to connect to distributed work bench locations.

Process Rules Executor: Process rules Executor 204-7 may be responsible for execution of business rules which was defined by process configuration sub system. This sub system is invoked through the Process Rules Gateway (PR).

Message Bus: The message bus 203 may provide the infrastructure for various sub systems in the environment to communicate to each other.

Some of the subsystems like JM 202-c, OR 202-d, CH 202-e, and EN 202-f may be communicatively coupled to an automatic application manager 206. The automatic application manager 206 is further communicatively coupled to a monitor 208.

The monitor 208 may provide user with monitoring capabilities of the system 200 at each sub level. User may be able to diagnose each and every sub system about its processing activities, resources utilized, and performance aspect of process execution. The monitor 208 may be further coupled to a store 210 that stores information about resource utilization information related to RAM, CPU cycles etc.

The architecture shown in FIG. 2 may be implemented using one or more hardware processors (not shown), and a computer-readable medium storing instructions (not shown) configuring the one or more hardware processors; the one or more hardware processors and the computer-readable medium may also form part of the system 200.

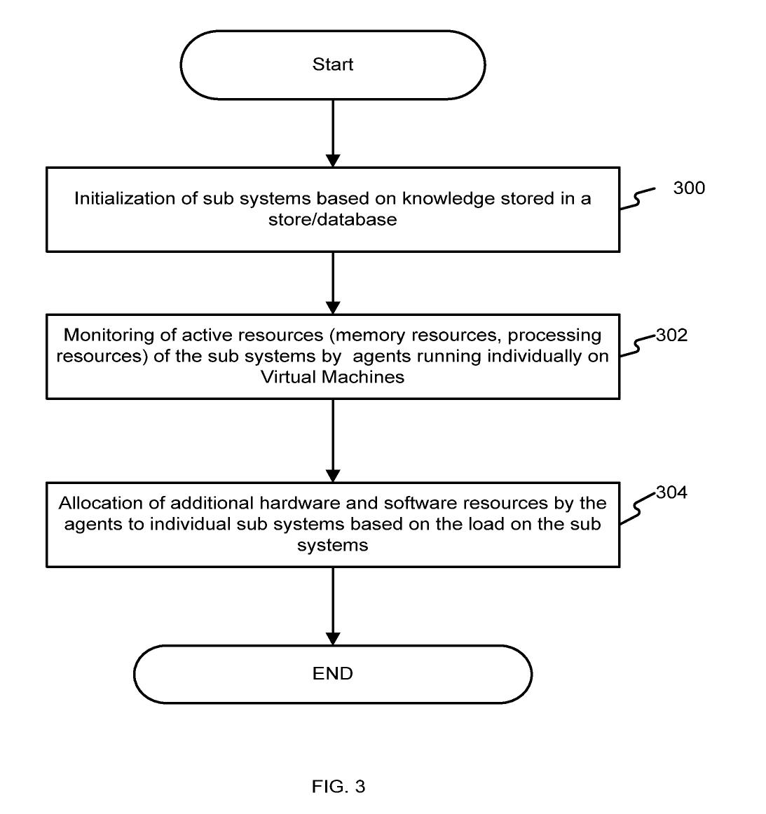

FIG. 3 is a flowchart of an exemplary method for selective scaling of one or more sub systems (202-a, 202-b, 202-c etc) disposed in cloud based business process management architecture in accordance with an example of this technology. The exemplary method may be executed by the system 200 as described in further detail below. It is noted however, the functions and/or steps of FIG. 3 as implemented by system 200 may be provided by different architectures and/or implementations without departing from the scope of the present disclosure.

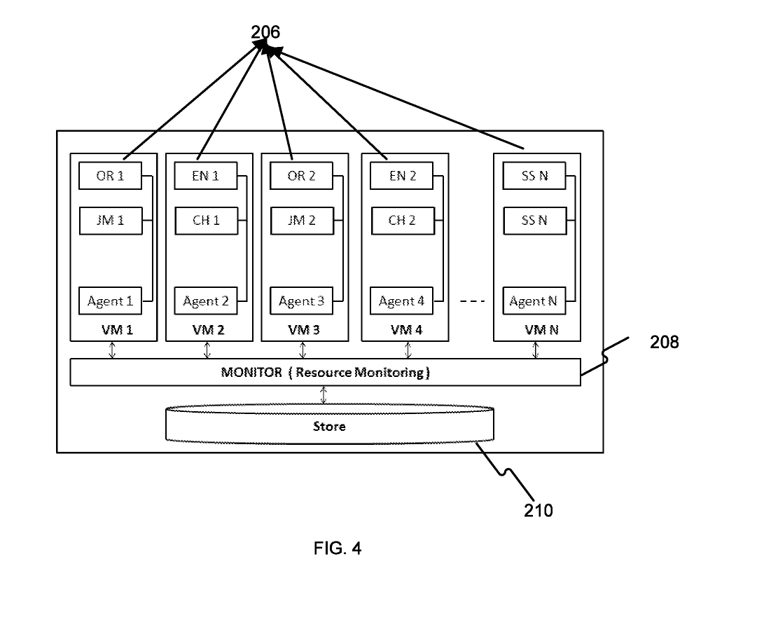

At step 300, the sub systems (202-a, 202-b, 202-c etc) communicatively coupled to the automatic application manager 206 may be initialized dynamically based on knowledge stored in the store 210. This knowledge information may provide the automatic application manager 206 to decide on amount of resources required for the sub systems and certain number of instances required for each sub system to process current and future load on the system 200. Due to non-availability of knowledge information for first time sub system instance creation and loading, startup process may initiate all the sub systems instances once and allocate minimum required resources to the created instances. FIG. 4 illustrates working of an exemplary automatic application manager 206 disposed in the system 200 in accordance with an example of this technology. The automatic application manager 206 may be having the provisioning for all hardware and software requirements of the sub systems

As shown in FIG. 4, the automatic application manager 206 may comprise a plurality of virtual machines VM1, VM2, VM3, VM4 VM N). The subsystems OR, JM, EN, and CH may be hosted and integrated to the VM1, VM2, VM3, VM4 VM N. FIG. 4 shows OR1 and JM1 hosted on the VM1, EN1 and CH1 hosted on the VM2, OR2 and JM2 hosted on the VM3, EN2 and CH2 hosted on the VM4. OR1 and JM1 may be instances of the subsystems OR and JM, respectively. OR2 and JM2 are another instances of the subsystems OR and JM, respectively. Similarly EN1 and EN2 may be different instances of the subsystem EN. CH1 and CH2 may be different instances of the subsystem CH. OR, JM, EN, and CH are the subsystems in general. Further, each VM is shown to be hosting two subsystems which is optimal for the architecture, but those two sub systems will be dynamically created as per load. Further, the number of sub systems hosted on each of the VM may vary. Any sub system may run on any of the VM.

Virtual Machines (VM) are the hardware infrastructure on which the sub systems are set up and executed. The set up and execution processes of sub systems is controlled by Agents (agent 1, agent 2, agent 3, . . . agent N on each individual VM space. Agents are responsible for instantiating the sub system instance by providing the required resources like memory, processing space etc. Agents are also responsible to monitor the sub system execution process and all the aspects of resource utilization on corresponding virtual memory space. Agent overseas the operations on each VMs Agent is like watch dog and performs required operations automatically as load increases on VM hardware. VM will be having defined set of hardware resources Agents are responsible for automatic up-scaling and downscaling of the sub systems on runtime and provide all the event information's that gets triggered on its corresponding VM space to the resource monitoring application (monitor) 208. Resource monitoring application will receive all the information and store the information on its store 402 for future use.

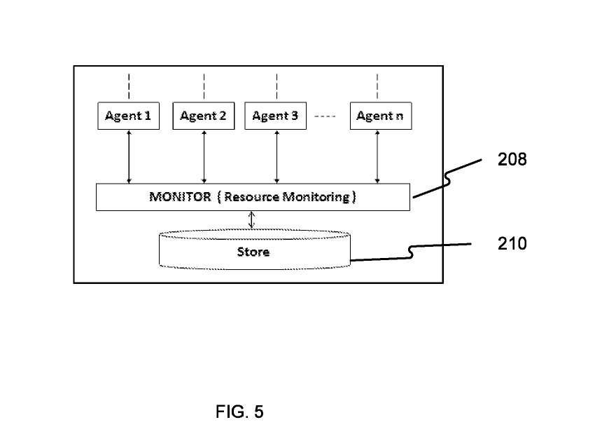

FIG. 5 illustrates working of an exemplary resource monitoring application (monitor) 208 communicatively coupled to the automatic application manager 206 in accordance with an example of this technology. The monitor 208 may provide user with the monitoring capabilities of the entire system at each sub system level. User may be able to diagnose each and every sub system about its processing activities, resources utilized and performance aspect of the process execution.

User may be able to diagnose all the metrics information with respect to number of sub system instances which are created or destroyed during the life cycle of an business process. All the resource utilization information related to RAM, CPU cycles, middleware's etc. which is running on entire virtual and cloud environments.

The resource monitoring application 208 gets or subscribes all the metrics data from the agents which are running on individual VMs. This metrics information can be transformed and stored in the store or database 210 for future use.

The metric information persisted onto the store can be used for knowledge management activities and data analysis. The runtime metric information can also be used to generate more user friendly report components such as graphs, texts etc.

Referring to FIG. 2, at step 302, active resources (memory resources, processing resources) are monitored by the agents running individually on VMs. Once all the sub system instances are loaded and executing its respective tasks, the resource monitoring application 208 will keep track of the activities going on each of the sub systems through the information obtained from the agents on the respective sub systems. The resource monitoring application 208 will have all the metrics information related to all the sub systems running with respect to its allocated resources. Hence with the help of this information user can monitor the progress of sub system activities on real time.

At step 304, hardware and software resources may be allocated by the agents to individual sub systems based on the load on the sub systems. There are two types of provisioning, i.e., allocation of resources like hardware provisioning and software provisioning.

Hardware provisioning: The agents may auto up-scale or auto down-scale based on the load on each sub systems. The agents may be responsible for auto creation and auto destruction of sub systems instances based on the load it receives. In the case of hardware provisioning, new instances of sub system are created and loaded separately on the virtual machine (VM) space, which has its own agent, memory space and CPU resources. In case where the agent finds there is no system load or very minimal load on the sub system instance created, then it will automatically destroy or kill the sub system instance and will reclaim all the resources. It is the agents who may decide whether there is load increasing on a sub system or decreasing on the subsystem. The decision is based on a predefined criterion. The predefined criterion may be different for the memory resources and CPU resources.

Software Provisioning: In the case of software provisioning, new instance of sub system is not created on virtual machine (VM) space, but on monitoring of higher load on the sub system instance which is currently executing, agent will allocate more resources like memory and space as required. Once the task is completed by the sub system and the load has reduced drastically the allocated resources will be collected back by the agent.

Agents which are running on each virtual machine (VM) space provides all relevant metric information with respect to sub systems and the resource utilized for the Resource Monitoring Application This metric information which is captured by the Resource Monitoring Application 208 will be stored as part of the resource monitoring store 400 or database. In one implementation, agents who provide this information will act upon certain set of data to create a snapshot of how the system behaved with respect to various loads at various intervals of time. So that this information can be used by agents to dynamically auto scale/auto down scale or for next re-start operations of the sub systems. Now any external application can be interfaced with the resource monitoring application 208 to have the view of all the metric information in form of texts, dashboards. Graphs, etc.

### Exemplary Computer System

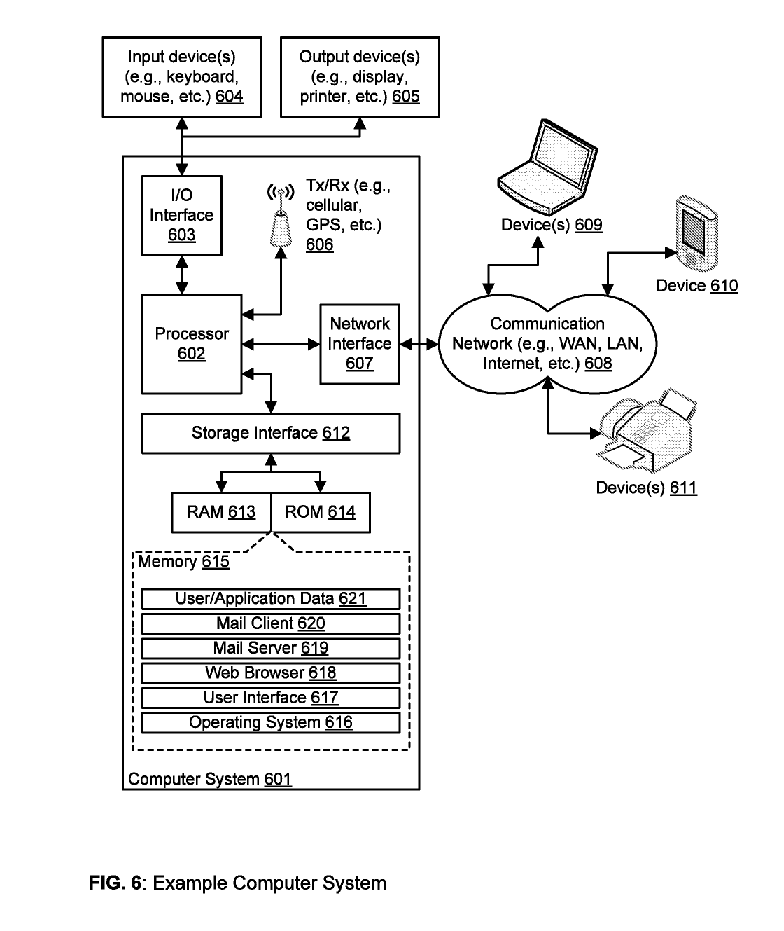

FIG. 6 is a block diagram of an exemplary process management computing device, also referred to as computer system 601, that implements this technology, although other types and/or numbers of systems or other devices could be used. Variations of computer system 601 may be used for implementing any of the devices and/or device components presented in this disclosure, including system 601. Computer system 601 may comprise a central processing unit (CPU or processor) 602. Processor 602 may comprise at least one data processor for executing program components for executing user- or system-generated requests. A user may include a person using a device such as such as those included in this disclosure or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 602 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 602 may be disposed in communication with one or more input/output (I/O) devices via I/O interface 603. The I/O interface 603 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 603, the computer system 601 may communicate with one or more I/O devices. For example, the input device 604 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 605 may be a printer, fax machine, video display (e.g., cathode ray tube (CRT), liquid crystal display (LCD), light-emitting diode (LED), plasma, or the like), audio speaker, etc. In some embodiments, a transceiver 606 may be disposed in connection with the processor 602. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 518-PMB9800, or the like), providing IEEE 802.11a/b/g/n, Bluetooth, FM, global positioning system (GPS), 2G/3G HSDPA/HSUPA communications, etc.

In some embodiments, the processor 602 may be disposed in communication with a communication network 608 via a network interface 607. The network interface 607 may communicate with the communication network 608. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 608 may include, without limitation, a direct interconnection, local area network (LAN), wide area network (WAN), wireless network (e.g., using Wireless Application Protocol), the Internet, etc. Using the network interface 607 and the communication network 608, the computer system 601 may communicate with devices 609. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 601 may itself embody one or more of these devices.

In some embodiments, the processor 602 may be disposed in communication with one or more memory devices (e.g., RAM 6 13, ROM 6 14, etc.) via a storage interface 612. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 6 16, user interface application 617, web browser 618, mail server 619, mail client 620, user/application data 621 (e.g., any data variables or data records discussed in this disclosure), etc. The operating system 616 may facilitate resource management and operation of the computer system 601. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 617 may facilitate display, execution, interaction, manipulation, or operation of program components through textual or graphical facilities. For example, user interfaces may provide computer interaction interface elements on a display system operatively connected to the computer system 601, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 601 may implement a web browser 618 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 601 may implement a mail server 619 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 601 may implement a mail client 620 stored program component. The mail client may be a mail viewing application, such as Apple Mail, Microsoft Entourage, Microsoft Outlook, Mozilla Thunderbird, etc.

In some embodiments, computer system 601 may store user/application data 621, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more non-transitory computer-readable storage media may be utilized in implementing this technology. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for selective scaling of one or more sub systems disposed in a cloud based business process management architecture, the method comprising:
monitoring, by a process management computing device, performance of each of the one or more sub systems to determine load existing on each of the one or more sub systems;
selecting, by the process management computing device, at least one sub system of the one or more sub systems based on the monitored performance
automatically scaling at least one of up or down, by the process management computing device, the at least one sub system by at least one of allocating or collecting back hardware and software resources to the at least one sub system based on the monitored performance.

2. The method of claim 1, wherein the scaling at least one of up or down of the at least one sub system of the one or more sub systems further comprises:
storing, by the process management computing device, data related to the load existing on each of the one or more sub systems;
at least one of creating or destroying, by the process management computing device, one or more instances of at least one sub system of the one or more sub systems based on load existing on the at least one subsystem.

3. The method of claim 2, wherein the at least one of scaling up or down of the at least one sub system of the one or more sub systems further comprises:
at least one of allocating or collecting, by the process management computing device, back resources to the one or more instances of the at least one sub system of the one or more sub systems based on load existing on the one or more instances.

4. The method of claim 3, further comprising initializing, by the process management computing device, the one or more sub systems based on the data related to the load existing on each of the one or more sub systems.

5. The method of claim 4, wherein the initializing the one or more sub systems for a first time comprises:
creating, by the process management computing device, one or more instances once; and
allocating, by the process management computing device,
predetermined resources to the created one or more instances.

6. The method of claim 3, further comprising creating, by the process management computing device, a snapshot as to how one or more sub systems behave at various instances of time.

7. The method of claim 6, wherein the automatically scaling at least one of up or down is based on the snapshot.

8. The method of claim 1, further comprising independently coupling, by the process management computing device, each of the one or more sub systems to a platform, the platform facilitating communication between the one or more sub systems.

9. A process management computing device comprising:
one or more hardware processors;
a computer readable medium storing programmed instructions that, when executed by the one or more hardware processors cause the one or more hardware processors to perform operations comprising:
monitoring performance of each of the one or more sub systems to determine load existing on each of the one or more sub systems;
selecting at least one sub system of the one or sub systems based on the monitored performance; and
at least one of automatically scaling up or down the at least one sub systems by at least one of allocating or collecting back hardware and software resources to the at least one sub system.

10. The device of claim 9, wherein the one or more hardware processors are configured to cause the one or more hardware processors to perform operations for the at least one of automatically scaling up or down of the at least one sub system of the one or more sub systems operation further comprising:
storing data related to the load existing on each of the one or more sub systems;
at least one of creating or destroying one or more instances of at least one sub system of the one or more sub systems based on load existing on the at least one sub system.

11. The device of claim 10, wherein the one or more hardware processors are configured to cause the one or more hardware processors to perform operations for the at least one of automatically scaling up or down of the at least one sub system of the one or more sub systems operation further comprising:
at least one of allocating or collecting back resources to the one or more instances of at least one sub systems of the one or more sub systems based on load existing on the one or more instances.

12. The device of claim 11, wherein the one or more hardware processors are configured to cause the one or more hardware processors to perform operations further comprising initializing the one or more sub systems based on the data related to the load existing on each of the one or more sub systems.

13. The device of claim 12, wherein the one or more hardware processors are configured to cause the one or more hardware processors to perform operations for the initializing the one or more sub systems for a first time further comprising:
creating one or more instances once; and
allocating predetermined resources to the created one or more instances.

14. The device of claim 11, wherein the one or more hardware processors are configured to cause the one or more hardware processors to perform operations further comprising creating a snapshot as to how one or more sub systems behave at various instances of time.

15. The device of claim 14, wherein the at least one of automatically scaling up or down one or more sub systems is based on the snapshot.

16. The device of claim 9, wherein each of the one or more sub systems is coupled independently to a platform, the platform facilitating communication between the one or more sub systems.

17. A non-transitory computer-readable medium storing instructions for selective scaling of one or more sub systems disposed in a cloud based business process management architecture that, when executed by one or more hardware processors, cause the one or more hardware processors to perform operations comprising:
monitoring performance of each of the one or more sub systems to determine load existing on each of the one or more sub systems;
selecting at least one sub system of the one or sub systems based on the monitored performance; and
at least one of automatically scaling up or down the at least one sub system by at least one of allocating or collecting back hardware and software resources to the at least one sub system.

18. The non-transitory computer-readable medium of claim 17, wherein the at least one of automatically scaling up or down of the at least one sub system of the one or more sub systems further comprises:
storing data related to the load existing on each of the one or more sub systems;
at least one of creating or destroying one or more instances of at least one sub system of the one or more sub systems based on load existing on the at least one sub system.

19. The non-transitory computer-readable medium of claim 18, wherein the at least one of scaling up or down of the at least one sub system of the one or more sub systems further comprises:
at least one of allocating or collecting back resources to the one or more instances of at least one sub systems of the one or more sub systems based on load existing on the one or more instances.

20. The non-transitory computer-readable medium of claim 19, further comprising initializing the one or more sub systems based on the data related to the load existing on each of the one or more sub systems.
